(19) United States
(12) Patent Application Publication
(10) Pub. No.: US 2026/0087738 A1
(43) Pub. Date: Mar. 26, 2026

(54) VIRTUAL REPRESENATION OF IDENTIFIED OBJECT-RELATED ACHIEVEMENTS

(71) Applicant: International Business Machines Corporation, Armonk, NY (US)

(72) Inventors: Xiao Xia Mao, Shanghai (CN); Jialei Ma, Shanghai (CN); Liang Ying Xu, Beijing (CN); Nan Nan Li, Shanghai (CN); Ting Chen, Beijing (CN); Xiao Feng Ji, Shanghai (CN)

(21) Appl. No.: 18/890,955

(22) Filed: Sep. 20, 2024

(51) Int. Cl. G06T 17/00

(52) U.S. Cl. CPC G06T 17/005

(57) ABSTRACT

Techniques are described with respect to a system, method, and computer program product for visualizing representations of achievements. An associated method includes generating at least one vector associated with a user; identifying an object associated with the user, assigning the at least one vector to a tree data structure based on the identified object; and visualizing the tree data structure within a virtual environment associated with the user.

### FIELD

This disclosure relates generally to virtual, augmented, mixed, and/or extended reality computing systems and more particularly to visualizing virtual representations of object-identified related achievements.

### BACKGROUND

Object recognition mechanisms including, but limited to You Only Look Once, Regions with Convolutional Neural Network, and the like may be utilized for the purpose of detecting objects within a physical space. These detected objects may subsequently be manipulated and visualized within virtual spaces for virtual/augmented/extended/mixed reality users.

### SUMMARY

Additional aspects and/or advantages will be set forth in part in the description which follows and, in part, will be apparent from the description, or may be learned by practice of the invention.

Aspects of an embodiment of the present invention disclose a method, system, and computer program product for visualizing representations of achievements. In some embodiments, a computer-implemented method for visualizing representations of achievements comprises generating at least one vector associated with a user; identifying an object associated with the user; assigning the at least one vector to a tree data structure based on the identified object; and visualizing the tree data structure within a virtual environment associated with the user.

In some embodiments, a plurality of user vectors are ascertained from user-specific profiles, in which the user vectors comprise one or more preferences, objectives, achievements, etc. associated with users and derivatives of the user vectors represent a maximum achievement combination visualized as a root node within a data structure (e.g., tree structure, etc.). Subsequently, intermediate nodes are generated representing all possible combinations of preferences, objectives, achievements, etc. based on the identified object associated with a user. In some embodiments, the user-specific profiles comprise user descriptions configured to be assigned to the nodes of the data structures, in which the assignment of a user to the node is based upon the user descriptions.

In some embodiments, the data structure is visualized within a virtual environment allowing users to view current and/or potential preferences, objectives, achievements, etc. associated with a detected object along with those relating to family, friends, colleagues, and the like.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a user-specific achievements visualization system environment, according to an exemplary embodiment;

FIG. 3 illustrates a block diagram of various modules associated with a personalization module and a visualization module of the system FIG. 2, according to an exemplary embodiment;

FIG. 4 illustrates object identification associated with a user of the system FIG. 2, according to an exemplary embodiment;

FIG. 5 illustrates a visualization of an achievement data structure, according to an exemplary embodiment; and

FIG. 6 illustrates an exemplary flowchart depicting a method for visualizing representations of achievements, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Due to the massive volume of data along with the large variability of data structure options, visualizing certain data structures poses to be a difficult for real-time renderings in various settings. Furthermore, virtual and/or augmented reality visualizations derived from data structures designed to handle large volumes may be impacted due to the fact that they may demand significant computing resources causing overlays and other relevant digital elements to be distorted. For example, digital elements visualized in virtual environments derived from object detection and other applicable techniques (e.g., You Only Look Once, Regions with Convolutional Neural Network, and the like) may be directly impacted due to various factors such as network bandwidth, latency, etc. As a result of the volatility due to the various requirements to sustain virtual environments in addition to the variability of data structure options poses drawbacks to not only visualizing digital elements, but also taking the next step of efficiently visualizing information derived from analyses of digital elements and their sources.

The following described exemplary embodiments provide a method, computer system, and computer program product for visualizing representations of achievements. Object detection, object classification, and other applicable techniques (e.g., You Only Look Once, computer vision, Regions with Convolutional Neural Network, and the like) not only allows for instances to be identified in digital images and videos, but also object analyses derived from the aforementioned facilitates information being ascertained and visualized within virtual environments associated with virtual reality, augmented reality, etc.-related systems. However, visualizing capabilities and consequences associated with detected objects tends to be difficult due to issues such as, but not limited to localization and the voluminous amount of information that may be associated with a given object. For example, an identified book may be associated with a countless amount of goals and objectives requiring contextual information (e.g., user preferences/capabilities, user objectives, and the like) to tailor the prospectives opportunities associated with acquiring knowledge from the identified book and/or opportunities unlocked from interactions with the identified book. Thus, the instant invention provides a means to reduce computational resources otherwise needed to not only identify significant objects within a given user's purview, but also take the next step of generating and visualizing a data structure configured to optimally depict prospective achievements and/or objectives tailored to a user derived from the identified objects in a scalable manner.

As described herein, an “achievement” is a current and/or prospective opportunity, skill, language, credential, hobby, event, awards, certifications, badges and the like associated with a user donning and/or associated with a computing device configured to support identification of objects. In some embodiments, achievements may be unlocked based upon one or more interactions of the user with the identified objects (e.g., reading a book, ascertaining a technique, engaging with a course, etc.). As described herein, an achievement may be digitally assigned to an interactive virtual element configured to be visualized in a virtual environment and receive virtual reality-based interactions (e.g., swiping, nodding, eye movements, linguistic inputs, etc.) from users and/or avatars within virtual spaces, which may trigger events.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

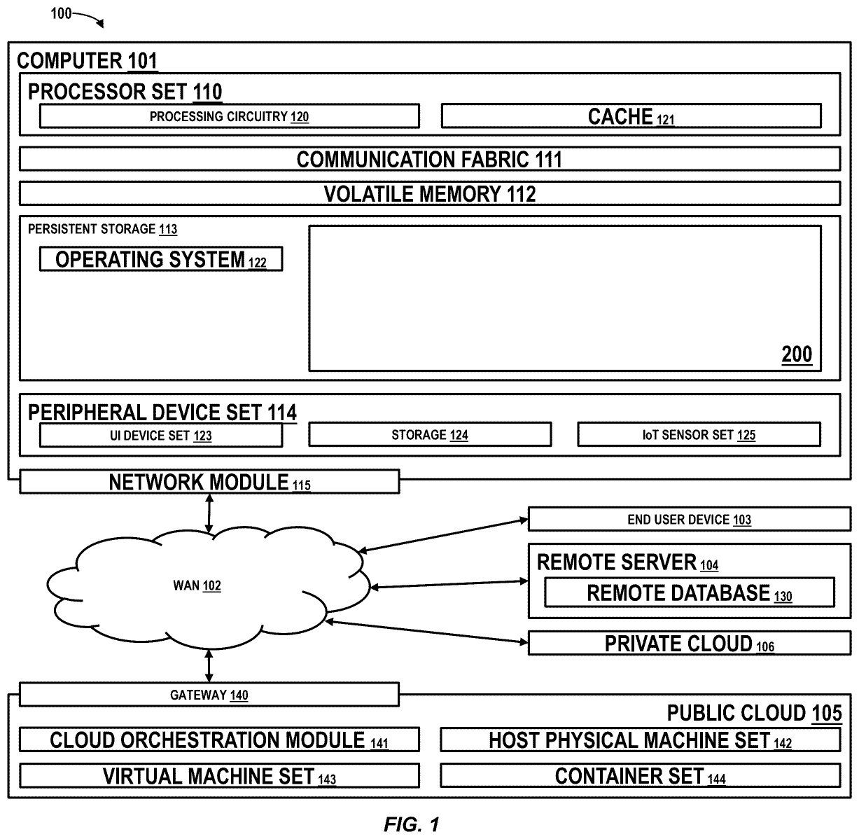

The following described exemplary embodiments provide a system, method, and computer program product for visualizing representations of achievements. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Furthermore, computing environment 100 contains an example of an environment for the execution of at least some of the computer code involved in performing the inventive methods, such as but not limited to improved cloud orchestration code, new ML algorithm code, etc. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

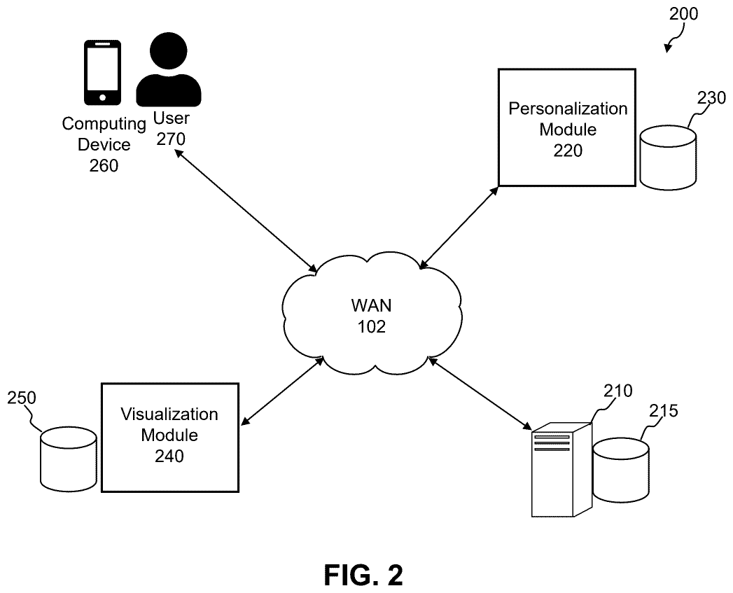

Referring now to FIG. 2, a functional block diagram of a networked computer environment illustrating a computing environment for user-specific achievements visualization system 200 (hereinafter “system”) comprising a server 210 communicatively coupled to a database 215, a personalization module 220 communicatively coupled to a personalization module database 230, a visualization module 240 communicatively coupled to a visualization module database 250, and a computing device 260 associated with a user 270, each of which are communicatively coupled over WAN 102 (hereinafter “network”) and data from the components of system 200 transmitted across the network is stored in database 215.

In some embodiments, server 210 is configured to operate a centralized platform serving as a cloud-based user-specific achievements visualization platform. Server 210 is configured to provide a mechanism for user 270 to not only view information, metrics, analytics, and the like associated with detected objects and/or relevant virtual objects (e.g., achievement data structures, interactive nodes, and the like), but also configure the user profile associated with user 270. In some embodiments, the centralized platform provides one or more user interfaces and application programming interfaces (APIs) to computing device 260 allowing user 270 interact with a given virtual environment along with virtual elements within the virtual environment. Server 210 is further configured to be communicatively coupled to one or more external data sources and comprise one or more web crawlers designed to ascertain relevant information associated with user 270 from internet-based sources subject to consent and permission granted by user 270. For example, social media related information derived from social media profiles associated with user 270 may be ascertained from one or more applicable social networks along with information relating to preferences, hobbies/interests, area of study, and like derived from other applicable internet-based sources. In some embodiments, the centralized platform provides mechanisms for achievements of various users associated with user 270 (e.g., family, colleagues, etc.) to be viewed and shared in a manner that allows ranking, competitive games, feedback, and the like within a collaborative environment.

Personalization module 220 is tasked with not only generating a user profile associated with user 270, but also maintaining a user vector associated with user 270 based on data derived from the user profile in order to ultimately facilitate visualizations of past, current, and prospective achievements associated with user 270 in a virtual environment. It should be noted that various types of data may be ascertained from server 210 and computing device 260 in order to generate the user profile and user vector including, but not limited to biological data (e.g., eye gaze/focus, pre-existing health conditions, allergies, etc.), interests, preferences, historical user activity (e.g., behavior, patterns, online activity, eye.) and any other ascertainable information associated with a user utilizing computer-mediated reality (CMR)/VR devices known to those of ordinary skill in the art. Furthermore, personalization module 220 is configured to generate one or more user descriptions based on objects identified by computing device 260 and subsequently classified by personalization module 220 for the purpose ascertaining current/prospective achievements. For example in the instance in which computing device 260 is a CMR device, computing device 260 identifies one or more books in a point-of-view associated with user 270 in which personalization module 220 utilizes one or more artificial intelligence-based mechanisms (e.g., convolutional neural network (CNN), deep learning neural network (DNN), You Only Look Once, computer vision, or the like) to classify and analyze the identified book(s). Subsequently, personalization module 220 generates target-user-feature vectors and/or query-user-feature vectors based on user descriptions derived from the user profile in order to ascertain current and/or prospective achievements associated with correlations between the books and user feature vectors. For example, if an identified book relates to learning languages and the user profile indicates user 270 enjoys learning languages then one or more prospective achievements are sent to visualization module 240 for integration into the construction of a data structure designed to be visualized within a virtual environment. It should be noted that the difference between target-user-feature vector and query-user-feature vector is that the target-user-feature vector converts the user description to the applicable user, and the query-user-feature vector converts the user description of the applicable user. In some embodiments, the achievements may be based on previous achievements associated with user 260, in which the user feature vectors are stored in personalization module database 230. In some embodiments, personalization module 220 comprises a user-description encoder designed to convert an input user description to a user-feature vector. It should be noted that one of the purpose of personalization module 220 is to generate achievement vectors once the user-feature vectors are generated, in which the achievement vectors are stored and utilized as source datasets by visualization module 240. In some embodiments, personalization module 220 instructs object identification in a manner that optimizes utilization of network bandwidth by establishing a threshold associated with whether an identified object is applicable to the achievements of user 270, in which the threshold is established based on one or more factors including, but not limited to network bandwidth, focus distance, contextual information ascertained from the user profile, natural language processing/linguistics processing (e.g., utterances of user 270), and the like. For example, if context ascertained from the user profile indicates that user 270 does not like to cook then objects within the perspective of computing device 260 that would otherwise have been detected, such as a cookbook, will be filtered out and will not be analyzed by personalization module 220 due to it not exceeding the threshold; therefore, network bandwidth and other applicable computing resources are optimized due to the calculated selectivity of personalization module 220.

Visualization module 240 is tasked with not only constructing the applicable data structure associated with achievements for user 270 based on identified objects, but also visualizing the applicable data structure within a virtual environment. It should be noted that one of the purposes of generating and visualizing the data structure is to allow user 270 to intuitively understand how their selections of learning-related assets (e.g., books, trainings etc.) and other applicable identified objects will impact them; thus, allowing user 270 to make targeted selections. In some embodiments, visualization module 240 may utilize a latent semantic analysis technique via natural language processing and other applicable artificial intelligence-based mechanisms, in particular distributional semantics, of analyzing relationships between relevant files and/or the user profile and the terms which the aforementioned comprises by producing a set of ascertained related content. The latent semantic analysis may recognize that words with close meaning may occur in similar context; thus, a matrix containing word counts and other applicable analytics may be constructed from a large file. Furthermore, a mathematical technique called singular value decomposition (SVD) may be used to reduce the number of data structure organization units (i.e., rows of the matrix) while preserving the similarity structure among columns of the matrix, while visualization module 240 simultaneously utilizes combinatorial methods in order to combine achievements. As a result, user feature vectors and achievements vectors are compared by taking the cosine of the angle between them. It should further be noted that visualization module 240 determines the largest subset of achievements that user 270 may simultaneously obtain based on the user profile and/or identified objects. This ultimately leads to the determined maximum achievement combination being represented via the applicable data structure within the given virtual environment. In some embodiments, visualization module 240 utilizes various selection algorithms to determine the set of achievements derived from one or more of server 210, computing device 260, and any other applicable data source that best matches the user-feature vector based on the distance measures. In some embodiments, a greedy algorithm may be implemented. The greedy algorithm is an algorithm that always makes the choice that provides the largest immediate benefit; therefore, the greedy algorithm tests all of the N+1 achievements to delete, and for each choice calculates the distance measure between that choice (i.e., the user-feature vector and achievement vector). The greedy algorithm then selects the deletion candidate remaining that has the minimum distance measure. Upon determination and assignment of the current and prospective achievements available to user 270 to the applicable data structure, visualization module 240 generates a visualization of the applicable data structure within the given virtual environment as a virtual element comprising interactive virtual objects. Visualization module 240 is configured to utilize generative adversarial networks and other applicable artificial intelligence-based mechanisms in order to generate virtual objects configured to be integrated into virtual environments that support functionalities such as, but not limited to virtual interactions (e.g., gesture-based responses, interactive chatbots, visual effects, etc.). For example, the applicable data structure may be a tree structure comprising a plurality of nodes in which the nodes represent current or perspective achievements presented to user 270 based on objects in the surrounding real world being identified, classified, and analyzed.

Computing device 260 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network or querying a database. It should be noted that in the instance in which computing device 260 is a CMR device (e.g., VR headset, AR goggles, smart glasses, etc.) or other applicable wearable device, computing device 260 is configured to collect sensor data via one or more associated sensor systems including, but are not limited to, cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IoT”) sensors, or any other applicable type of sensors known to those of ordinary skill in the art.

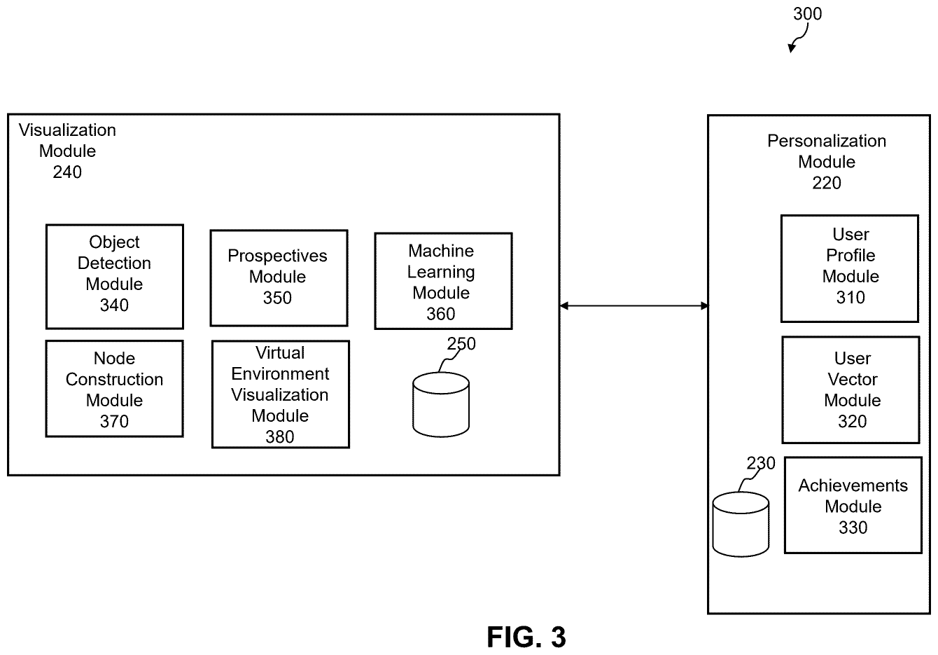

Referring now to FIG. 3, an example architecture 300 of personalization module 220 and visualization module 240 is depicted, according to an exemplary embodiment. In some embodiment, personalization module 220 comprises a user profile module 310, a user vector module 320, and an achievements module 330. Visualization module 240 comprises an object detection module 340, a prospectives modules 350, a machine learning module 360, a node construction module 370, and a virtual environment visualization module 380. Outputs of one or more machine learning models operated by machine learning module 360 are configured to be stored in one or more of database 215, personalization module database 230, and visualization module database 250, in which the machine learning models may train datasets based on data derived from one or more of server 210, personalization module 220, visualization module 240, and any other applicable data sources (e.g., internet-based data sources).

User profile module 310 is configured to generate user profiles associated with user 270 and any other applicable users operating on the centralized platform. It should be noted that the user profiles are utilized as a compilation of data associated with users operating on the centralized platform, in which various information relating to users including but not limited to user preferences, interest, habits/routines, biological data (e.g., physical features, cultural-based data, etc.) user behavior data, user interaction data, user internet browsing-based data, social media-based data, learning profile data, and any other applicable user data known to those of ordinary skill in the art is continuously collected, analyzed, and updated. In some embodiments, the user profile is analyzed by user profile module 310 in order to ascertain contextual information for the purpose of supporting filtering of identified objects based on relevancy of the object to user 270. For example, the user profile is utilized to establish the threshold associated with whether an identified object is applicable to the achievements of user 270, in which the threshold is established based on one or more factors including, but not limited to network bandwidth, focus distance, contextual information, and the like.

User vector module 320 is designed to generate and maintain the user-feature vectors associated with user 270. In some embodiments, user vector module 320 comprises one or more encoders configured to convert inputs such as user descriptions derived from the user profile to user-feature vectors as inputs are iteratively fed into the encoders. In some embodiments, user vector module 320 communicates with machine learning module 360 in order to train the one or more encoders utilizing contrastive learning. For example, each time user descriptions of user 270 are assigned to the applicable data structure such as a tree, all tree nodes (including root and leaf nodes) are randomly selected and respectively fed into the one or more encoders allowing user vector module 320 to calculate contrastive loss based on the cosine similarity from the Siamese Neural Network and a dynamically determined training label. User description may also be assigned to unassigned leaf nodes. Backpropagation may be utilized to update the parameters of the encoders and the training will be continued until convergence. In some embodiments, node construction module 370 determines the upper-most node level of the applicable data structure based on the user-feature vectors. Furthermore, user vector module 320 calculates the cosine similarity between the respective user feature vectors from the one or more encoders.

Achievements module 330 is tasked with generating one or more achievement vectors along with an achievement co-occurrence matrix based on the user profile so that the learned achievement vectors can be obtained and saved to personalization module database 230. In some embodiments, achievements module 330 trains a GloVe (Global Vectors for Word Representation) model with the achievement co-occurrence matrix until convergence in order to ultimately determine a largest subset of achievements that user 270 may simultaneously obtain with the identified objects. In some embodiments, achievements module 330 utilizes a greedy algorithm based on the obtained achievement vectors allowing visualization module 240 to represent the determined maximum achievement combination as the topmost root node of the applicable data structure (e.g., achievement-combination tree). Achievements module 330 communicates with prospectives module 350 in order for prospectives module 350 to aggregate the achievements in the maximum achievement combination utilizing one or more combinatorial methods, including but not limited to Binomial Theorem, Generating Functions, Recurrence Relations, Graph Theory, and the like; wherein each achievement serves as an element of the combination, in order to obtain all possible achievement combinations. In addition, achievements module 330 communicates with node construction module 370 allowing node construction module 370 to generate the applicable data structure comprising the obtained achievement combination. It should be noted that achievement-combination data structures have a high likelihood of being difficult to visualize due to the voluminous amount of achievements available based on the identified objects. Achievements module 330 rectifies the aforementioned issue by determining a largest subset of achievements user 270 may simultaneously obtain based on one or more factors including but not limited to contextual information, time period, time requirements associated with an achievement, and any other applicable filters known to those of ordinary skill in the art. For example, data indicating achievements obtained by user 270 and/or colleagues in a learning organization within a predetermined period of time. For any given achievement in such a subset, there is at least one or more other achievements (within the same subset) that are frequently obtained by user 270 simultaneously, and all the achievements within that subset form an achievement combination; thus, the subset serves as a guiding and attainable goal for learning and practice by user 270. Furthermore, achievements module 330 creates co-occurrence matrix X, based on the collected historical data of obtained achievements per user, where each entry Xᵢⱼ represents the number of times achievements i and j were obtained by the same user. The objective of the GloVe (Global Vectors for Word Representation) model for training achievement vectors is as below, where w∈R^{d} are achievement vectors and d represents the dimension number of an achievement vector: J(w)=Σ_{i,j}f(Xᵢⱼ)(wᵢ^{T}wⱼ−log Xᵢⱼ)². The selected weighting function

$$f ( {X}_{ij} ) is : f ( {X}_{ij} ) = \{ \begin{matrix}{( {X}_{ij} / {X}_{max} )}^{α} & if {X}_{ij} / {X}_{max} \\ 1 & otherwise\end{matrix} .$$

Object detection module 340 is tasked with communicating with computing device 260 in order to perform object identification of objects within the perspective of user 270. It should be noted that object detection module 340 performs object identification in a manner that reduces the amount of computing resources otherwise necessary by communicating with machine learning module 360 to automate detection capabilities through experience and/or repetition without procedural programming. For example, object detection module 340 may utilize machine learning module 360 to analyze data ascertained from the user profile, historical user movements and/or trajectories when moving through physical spaces and/or virtual environments, natural language processing/linguistics processing, and the like in order to determine which objects within the perspective of user 270 should be candidates for identification. For example, user 270 may utter and/or indicate that they would like to go on a diet while traversing a bookstore, in which object detection module 340 processes the utterance resulting in cookbooks within the perspective of user 270 that comprise recipes for foods that are counterintuitive to eating healthy. Not only does the aforementioned approach prevent computing device 260 from utilizing otherwise necessary resources to perform detecting and processing of irrelevant objects within the perspective of user 270, but also utilization of network bandwidth is optimized by object detection module 340 processing the thresholds associated with whether an identified object is relevant to user 270. Therefore, object detection module 340 iteratively filters out irrelevant objects preventing them from being listed as potential candidates for identification.

Prospectives module 350 is tasked with aggregation of achievements associated with user 270 (e.g., past and current) in order ascertain prospective achievements. In some embodiments, prospectives module 350 ascertains the prospective achievements based on one or more of the user profile, contextual information, previous and current objects identified by object detection module 340, and the like. Prospectives module 350 aggregates the achievements in the maximum achievement combination utilizing one or more combinatorial methods, wherein each achievement serves as an element of the combination, in order to obtain all possible achievement combinations. There are a variety of factors that may be taken into account when prospectives module 350 is determining prospective achievements including but not limited to the user profile, contextual information, environment of the physical space user 270 is occupying, and the like. Prospectives module 350 may utilize natural language processing (NLP), computer vision, image analysis, topic identification, virtual object recognition, setting/environment classification, and any other applicable artificial intelligence and/or cognitive-based techniques known to those of ordinary skill in the art in order to assist with ascertaining prospective achievements. Prospectives module 350 aggregates the achievements by generating descriptions derived from the user profile and/or identified objects comprising one or more metrics pertaining to identified object type (i.e., classification), content, level of completion relating to user 270, summary of identified object, and the like, in which prospectives module 350 merges the descriptions based on the user profile resulting in one or more hybrid descriptions subsequently converted into one or more vectors for assignment to the applicable data structure by node construction module 370. Furthermore, prospectives module 350 is configured to convert descriptions to user feature vectors upon assignment based on the manner of traversal of the applicable data structure by node construction module 370. Prospectives module 350 is also tasked with suggesting prospective achievements for user 270 based on past, current, and prospective achievements associated with family, friends, and colleagues of user 270, in which statuses and analytics of the aforementioned are displayed to user 270 on computing device 260. For example, one or more objects may be identified and suggested to user 270 based on a friend, family, colleague, etc. receiving a badge/certification, in which the relevant object necessary to obtain the badge/certification (e.g., similar book, course load, associated objects, etc.) is presented to user 270 if available within the applicable physical space.

Machine learning module 360 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. For example, machine learning module 350 is designed to maintain one or more machine learning models dealing with training datasets including data derived from one or more of database 215, personalization module database 230, visualization module database 250, and any other applicable data source. In some embodiments, machine learning module 360 performs federated learning, which is a process for using machine learning algorithms to train models without necessitating the training data to be stored in a central location, such as database 215. For example, machine learning module 350 may employ a federated learning process by training respective machine learning models based on confidential data sets. Machine learning module 360 may further share one or more derivatives of the trained models, such as model weights or gradients with respect to the data points, for aggregation purposes. In some embodiments, the one or more machine learning models are designed to output predictions pertaining user 270, the user profile, contextual information, candidates for object identification, prospective achievements, and the like. For example based off of sensor data derived from computing device 260 (e.g., gaze detection, threshold amount of time interacting with physical object, etc.), machine learning module 360 may utilize one or more machine learning models to generate outputs relating to prospective objects within the physical space associated with user 270 that may be of interest. Furthermore, previously analyzed contextual information may be utilized for future iterations in order to optimize suggestions for prospective achievements and/or achievement combinations to be visualized with the virtual environment.

Node construction module 370 is tasked with constructing the applicable nodes of the applicable data structure representing achievements associated with user 270. It should be noted that node construction module 370 may construct a tree in a manner in which each leaf node on the tree represents an individual achievement, and each tree node (including the topmost root node) represents a combination of multiple achievements. In some embodiments subsequent to ascertaining the achievement vector associated with user 270, a starting node of the tree is represented as a current achievement of user 270, in which the current user description of user 270 is assigned in a predetermined manner based on the related user-feature vector of the current user description. Node construction module 370 traverses each node above the starting node, which was assigned to current user descriptions of other users operating on the centralized platform when building the achievement-combination tree in a predetermined traversal order (e.g., depth-first traversal). Other applicable predetermined traversal orders are within the spirit and scope of the application. For each traversed node, node construction module 370 converts one of its assigned current user descriptions to a user-feature vector and cacluates cosine similarity between the applicable user-feature vector and the traversed-user-feature vector. If the calculated cosine-similarity value exceeds a preset threshold (e.g., a dynamically adjustable threshold), the user's description can be assigned to the corresponding traversed tree node, in which the ultimate objective is to locate a most upper-level node, which will be subsequently visualized within a virtual environment by virtual environment visualization module 380. In some embodiments, an ascertained achievement combination can serve as an intermediate tree node (representing a multi-achievement combination) or a leaf node (representing a single-achievement combination) of the achievement-combination tree. The number of elements (i.e., achievements) in an achievement combination represented by an intermediate tree node (including root node) decreases layer by layer from top to bottom, and the respective numbers of elements in the achievement combinations represented by tree nodes on the same level are the same.

Virtual environment visualization module 380 is tasked with rendering interactive visualizations of the aforementioned data structure within a virtual environment. In some embodiments, virtual environment visualization module 380 comprises generative adversarial networks and any other applicable artificial intelligence based mechanisms necessary to render virtual objects in a scalable manner configured to support interaction with user 270 within a virtual environment. The applicable data structure comprises a plurality of digital objects representing the aforementioned nodes reflecting achievements, in which user 270 may apply one or more virtual interactions to the nodes (e.g., gestures, eye movements, swiping, etc.) causing reactions to the nodes including but not limited to movement, scrolling, strobing/flashing, minimizing size, maximizing size, and any other applicable virtual environment-based effects known to those of ordinary skill in the art. In some embodiments, user 270 may have access to applicable data structures representing the achievements of friends, family, and colleagues in order for the centralized platform to provide gaming-based experience where users can compete, score, and prioritize achievements within a collaborative virtual environment. Metrics and analytics relating to identified objects and prospective achievements ascertainable by interactions with identified objects may be presented to user 270 on computing device 260. For example, an identified object within the perspective of user 270 may be a high protein food, in which metrics, analytics (e.g., descriptive information), and prospective achievements associated with consumption of the identified object may be presented to user 270.

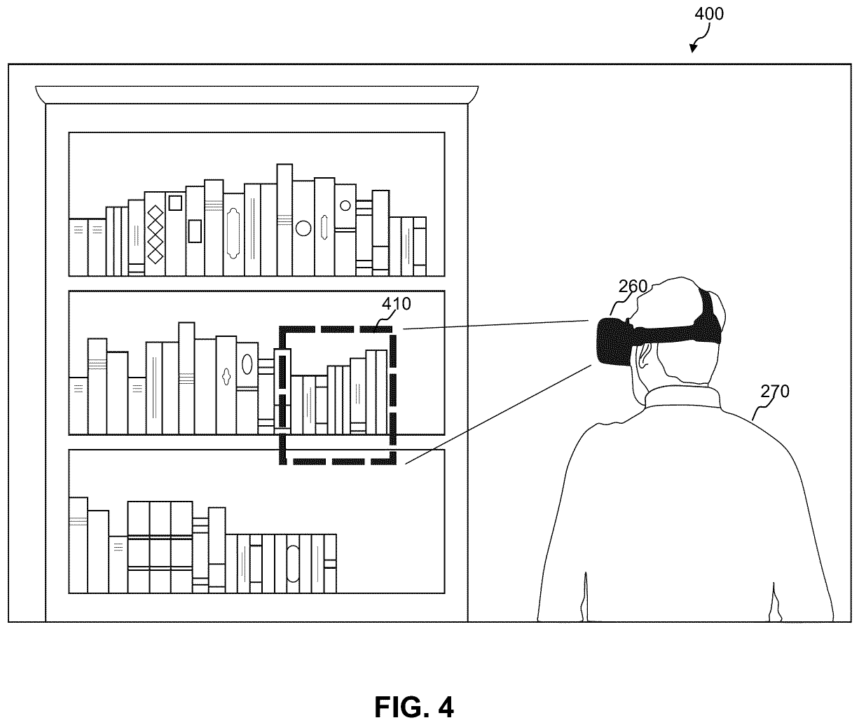

Referring to FIG. 4, user 270 interacts with physical space 400, according to an exemplary embodiment. User 270 in possession of and/or donning computing device 260 facilitates object detection 410 of the one or more books within the perspective of user 270. It should be noted that information associated with the identified objects may be presented to user 270 within the applicable virtual environment such as object characteristics (e.g., object type, dimensions, properties, purpose, etc.), level of potential interest of object to user 270 based on outputs of the one or more machine learning models trained on data derived from the user profile, applicable crowdsourced data relating to the identified object, and the like. As previously mentioned, computing device 260 may be AR glasses, goggles, a smartphone, a CMR device, and the like, in which other users in any physical surrounding and/or virtual environment may influence identification of objects by object detection module 340 in a collaborative approach. Furthermore, identified objects may be ranked/scored and the given properties of the objects based on what types of impact the object may have with respect to user 270 (e.g., positively, negatively, etc.). This approach assists with ascertaining which prospective achievements associated with user 270 should be prioritized and recommend appropriate actions for user 270 to perform in relation to the identified object. Accordingly, computing device 260 will display to user 270 the achievement-based data structure in relation to the object and/or object properties so that user can identify what to endeavor. In some embodiments, user profile module 310 may maintain one or more object profiles comprising object properties and like associated with detect objects, in which the object profiles may be taken into consideration when vectors are analyzed.

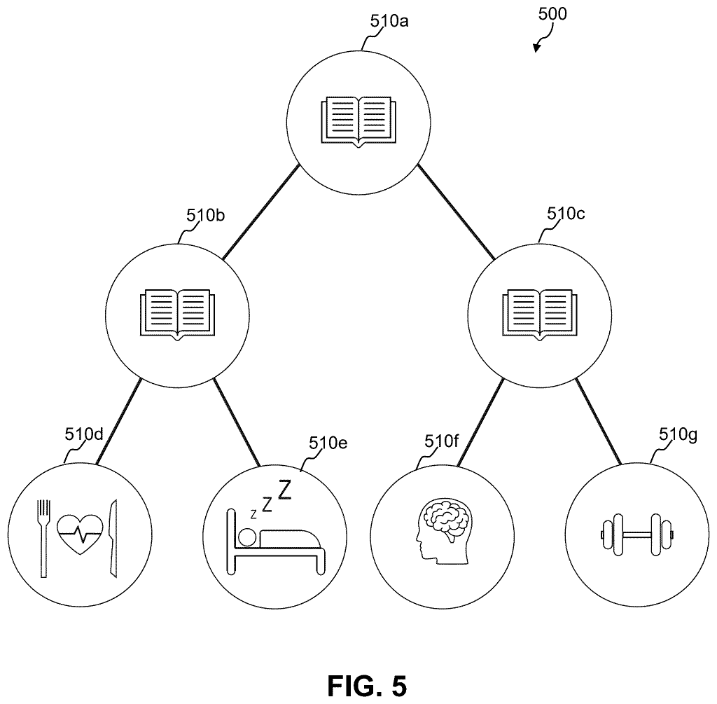

Referring to FIG. 5, an achievement data structure 500 is depicted, according to an exemplary embodiment. Achievement data structure 500 comprises a plurality of nodes 510a-g representing past, current, and/or prospective achievements associated with user 270 generated based on objects within the perspective of user 270 and analyses of the user profile. It should be noted that achievement data structure 500 is a 2D and/or 3D structure visualized within a digital environment (e.g., 3D virtual environment) presented to user 270 via computing device 260, in which nodes 510a-g are interactive virtual objects which may be generated based on CLIP-guided Generative Latent Space (CLIP-GLS) analyses and any other applicable means to render digital object known to those of ordinary skill in the art. In the some embodiments, the applicable machine learning models utilize scoring to render virtual objects with higher utility in future generative iterations. Nodes 510a-g are continuously being updated based on one or more modifications to the user profile, accomplishments of achievements associated with friends, family, and/or colleagues of user 270, outputs of the or more machine learning models, and the like. Traversal of achievement data structure 500 may be depth-first traversal, in-order, post-order, pre-order, breadth-first, or any other applicable traversal approach suitable to the applicable data structure. Nodes 510a-g support virtual interactions with user 270 allowing for an immersive experience comprising visual effects, links to applicable relevant data-sources, initiating virtual chatbots, and the like based upon user 270 engaging the applicable node (e.g., tap, swiping gesture, utterance, etc.).

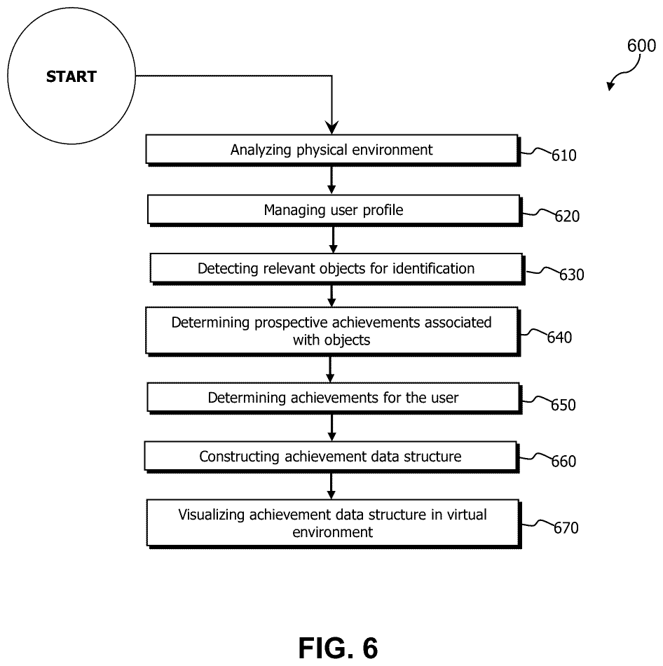

With the foregoing overview of the example architecture, it may be helpful now to consider a high-level discussion of an example process. FIG. 6 depicts a flowchart illustrating a computer-implemented process 600 for visualizing representations of achievements, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, computing device 260 analyzes a physical space associated with user 270. Physical spaces may be analyzed by one or more artificial intelligence-based mechanisms including, but not limited to computer vision, image analysis, topic identification, virtual object recognition, setting/environment classification, and the like. In some embodiments, computing device 260 utilizes one or more sensor systems to acquire sensor data (e.g., images, videos, sound/linguistic inputs, applicable multi-media, etc.) associated with the applicable physical space relevant to user 270.

At step 620 of process 600, user profile module 310 generates and/or manages the user profile associated with user 270. The user profile is being continuously updated with data sourced from one or more of server 210, personalization module database 230, visualization module database 250, computing device 260, and the like. Preferences of user 260, relevant objects of interest, social media information, objectives of other users, etc. associated with user 260 may be accounted for in the user profile. In some embodiment, the user profiles may be taken into account during identification and/or classification of objects deemed to be relevant to user 270 for the purpose of achievement suggestions.

At step 630 of process 600, object detection module 340 detecting relevant objects for identification within the physical space based on analyses of the user profile. Personalization module 220 utilizes one or more artificial intelligence-based mechanisms (e.g., convolutional neural network (CNN), deep learning neural network (DNN), You Only Look Once, computer vision, or the like) in order for object detection module 340 to classify and analyze the identified book(s) within the applicable physical space.

At step 640 of process 600, prospectives module 350 determines prospective achievements based on the identified objects. In some embodiments, personalization module 220 is configured to generate one or more user descriptions based on objects identified by computing device 260 and subsequently classified by personalization module 220 for the purpose ascertaining current/prospective achievements. Prospectives module 350 to aggregate the achievements in the maximum achievement combination utilizing one or more combinatorial methods, including but not limited to Binomial Theorem, Generating Functions, Recurrence Relations, Graph Theory, and the like; wherein each achievement serves as an element of the combination, in order to obtain all possible achievement combinations.

At step 650 of process 600, prospectives module 350 determines prospective achievements specifically for user 270. It should be noted that prospective achievements may be determined based on various factors including, but not limited to achievements associated with other users in the network relevant to user 270, previous achievements of user 270, analyses of the user profile, and the like.

At step 660 of process 600, node construction module 370 constructs an achievement data structure based on the determined achievements. In some embodiments, node construction module 370 determines the upper-most node level of the applicable data structure based on the user-feature vectors and user vector module 320 calculates the cosine similarity between the respective user feature vectors from the one or more encoders. Prospectives module 350 aggregates the achievements by generating descriptions derived from the user profile and/or identified objects comprising one or more metrics pertaining to identified object type (i.e., classification), content, level of completion relating to user 270, summary of identified object, and the like, in which prospectives module 350 merges the descriptions based on the user profile resulting in one or more hybrid descriptions subsequently converted into one or more vectors for assignment to the applicable data structure by node construction module 370. Furthermore, prospectives module 350 is configured to convert descriptions to user feature vectors upon assignment based on the manner of traversal of the applicable data structure by node construction module 370.

At step 670 of process 600, virtual environment visualization module 380 visualizes the achievement data structure in the applicable virtual environment. In some embodiments, the achievement data structure is a tree data structure, in which vectors are assigned to the tree data structure based on the identified object(s). The tree data structure is visualized within virtual environments, in which the achievements are virtual objects configured to support real-time interactions with user 270 and/or the applicable avatar via computing device 260. In some embodiments, virtualizations of the tree data structure is accomplished by generative adversarial networks and any other applicable artificial intelligence based mechanisms necessary to render virtual objects in a scalable manner configured to support interaction with user 270 within the virtual environment.

Based on the foregoing, a method, system, and computer program product have been disclosed. However, numerous modifications and substitutions can be made without deviating from the scope of the present invention. Therefore, the present invention has been disclosed by way of example and not limitation.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for visualizing representations of achievements, the method comprising:
generating, by a computing device, at least one vector associated with a user;
identifying, by the computing device, an object associated with the user;
assigning, by the computing device, the at least one vector to a tree data structure based on the identified object; and
visualizing, by the computing device, the tree data structure within a virtual environment associated with the user.

2. The computer-implemented method of claim 1, wherein assigning the at least one vector comprises:
analyzing, by the computing device, the at least one vector to generate a maximum achievement associated with the user;
wherein the analysis is based on one or more of a user profile, an object profile, and a plurality of contextual information associated with the user.

3. The computer-implemented method of claim 1, wherein assigning the at least one vector comprises:
assigning, by the computing device, a plurality of user vectors to the tree data structure;
wherein the plurality of user vectors are trained on at least a plurality of achievements and the plurality of achievements are represented by one or more leaf nodes of the tree data structure.

4. The computer-implemented method of claim 1, wherein the one or more leaf nodes of the tree data structure representing the plurality of achievements are associated with the identified object.

5. The computer-implemented method of claim 1, wherein assigning the at least one vector comprises:
traversing, by the computing device, each node of the one or more leaf nodes above a root node in a pre-determined order;
wherein a leaf node represents a single achievement and an intermediate tree node represents a multi-achievement combination.

6. The computer-implemented method of claim 3, wherein assigning the at least one vector comprises:
extracting, by the computing device, a plurality of textual descriptions from the one or more leaf nodes to generate a plurality of user descriptions; and
assigning, by the computing device, at least one user description of the plurality of user descriptions to an unassigned leaf node.

7. The computer-implemented method of claim 1, wherein the tree data structure comprises one or more leaf nodes functioning as interactive virtual objects within the virtual environment.

8. A computer program product for visualizing representations of achievements, the computer program product comprising or more computer readable storage media and program instructions collectively stored on the one or more computer readable storage media, the stored program instructions comprising:
program instructions to generate at least one vector associated with a user;
program instructions to identify an object associated with the user;
program instructions to assign the at least one vector to a tree data structure based on the identified object; and
program instructions to visualize the tree data structure within a virtual environment associated with the user.

9. The computer program product of claim 8, wherein program instructions to assign the at least one vector further comprise:
program instructions to analyze the at least one vector to generate a maximum achievement associated with the user;
wherein the analysis is based on one or more of a user profile, an object profile, and a plurality of contextual information associated with the user.

10. The computer program product of claim 8, wherein program instructions to assign the at least one vector further comprise:
program instructions to assign a plurality of user vectors to the tree data structure;
wherein the plurality of user vectors are trained on at least a plurality of achievements and the plurality of achievements are represented by one or more leaf nodes of the tree data structure.

11. The computer program product of claim 8, wherein the one or more leaf nodes of the tree data structure representing the plurality of achievements are associated with the identified object.

12. The computer program product of claim 8, wherein program instructions to assign the at least one vector further comprise:
program instructions to traverse each node of the one or more leaf nodes above a root node in a pre-determined order;
wherein a leaf node represents a single achievement and an intermediate tree node represents a multi-achievement combination.

13. The computer program product of claim 10, wherein program instructions to assign the at least one vector further comprise:
program instructions to extract a plurality of textual descriptions from the one or more leaf nodes to generate a plurality of user descriptions; and
program instructions to assign at least one user description of the plurality of user descriptions to an unassigned leaf node.

14. The computer program product of claim 8, wherein the tree data structure comprises one or more leaf nodes functioning as interactive virtual objects within the virtual environment.

15. A computer system for visualizing representations of achievements, the computer system comprising:
one or more processors;
one or more computer-readable memories;
program instructions stored on at least one of the one or more computer-readable memories for execution by at least one of the one or more processors, the program instructions comprising:
program instructions to generate at least one vector associated with a user;
program instructions to identify an object associated with the user;
program instructions to assign the at least one vector to a tree data structure based on the identified object; and
program instructions to visualize the tree data structure within a virtual environment associated with the user.

16. The computer system of claim 15, wherein program instructions to assign the at least one vector further comprise:
program instructions to analyze the at least one vector to generate a maximum achievement associated with the user;
wherein the analysis is based on one or more of a user profile, an object profile, and a plurality of contextual information associated with the user.

17. The computer system of claim 15, wherein program instructions to assign the at least one vector further comprise:
program instructions to assign a plurality of user vectors to the tree data structure;
wherein the plurality of user vectors are trained on at least a plurality of achievements and the plurality of achievements are represented by one or more leaf nodes of the tree data structure.

18. The computer system of claim 15, wherein the one or more leaf nodes of the tree data structure representing the plurality of achievements are associated with the identified object.

19. The computer system of claim 17, wherein program instructions to assign the at least one vector further comprise:
program instructions to traverse each node of the one or more leaf nodes above a root node in a pre-determined order;
wherein a leaf node represents a single achievement and an intermediate tree node represents a multi-achievement combination.

20. The computer system of claim 15, wherein program instructions to assign the at least one vector further comprise:
program instructions to extract a plurality of textual descriptions from the one or more leaf nodes to generate a plurality of user descriptions; and
program instructions to assign at least one user description of the plurality of user descriptions to an unassigned leaf node.
